(19) United States
(12) Patent Application Publication
(10) Pub. No.: US 2010/0159362 A1
(43) Pub. Date: Jun. 24, 2010

(54) METHOD OF PRODUCING SEPARATOR PLATE FOR FUEL CELL AND FUEL CELL UTILIZING THE SAME

(76) Inventors: Yoichi Ito, Tokyo (JP); Hiroshi Ueno, Tokyo (JP); Tamotsu Muto, Tokyo (JP)

Correspondence Address: LEIGHTON K. CHONG;PATENT ATTORNEY, 133 KAAI STREET, HONOLULU, HI, 96821, US

(21) Appl. No.: 12/601,118

(22) PCT Filed: Jun. 20, 2008
(86) PCT No.: PCT/JP2008/061295

§ 371 Date: Nov. 20, 2009

(30) Foreign Application Priority Data
Jun. 27, 2007 (JP) 2007-169390

(51) Int. Cl. H01M 2/14; H01M 2/00

(52) U.S. Cl. 429/514; 427/115

(57) ABSTRACT

A pattern of a reaction gas flow passage in a separator plate of a fuel cell is formed by screen printing with high accuracy. The invention relates to a method of producing a separator plate for fuel cell, the method including forming a partition wall 11 having a predetermined pattern which is to be a reaction gas flow passage on a base plate 10a, wherein two or more coats of an ink composition containing a conductive material are laminated on the base plate by screen printing to form conductive ink layers 11a to 11c having a predetermined thickness as the partition wall 11.

### TECHNICAL FIELD

The present invention relates to a method of producing a separator plate for fuel cell and a fuel cell utilizing the separator plate, and particularly to a method of producing a separator plate for polymer electrolyte membrane fuel cells (PEMFC) used in, for example, automobile, domestic and portable electronic devices, a separator plate obtained by the production method and a fuel cell using the separator plate.

### BACKGROUND ART

PEMFC have a higher output density than other fuel systems and therefore, studies have been made concerning these PEMFC for use as power sources of automobiles and as mobile power sources. Here, the structure of a unit cell of the PEMFC is shown in FIG. 11. A cell 1 includes a hydrogen electrode 5 provided with a support current collector 5a and an oxygen electrode 7 provided with a support current collector 7a, these electrodes being disposed on each side of an electrolyte membrane 3 and integrated to form a membrane/electrode assembly (MEA). The motive force of this unit cell 1 is usually about 0.6 to 1.0 V and therefore, two or more of these cells 1 are laminated to obtain the desired output. A fuel cell body is therefore called a cell stack because it is produced by laminating these cells 1 and a separator plate 10 is interposed between these cells 1.

Grooves having a depth of 1 mm to a little less than 1 mm are formed by digging on the surface or backside or both sides of the separator plate 10 to pass hydrogen as the reacting gas and oxygen (air). It is necessary for the separator plate 10 to have gas impermeability because it is necessary to supply the reaction gas to the entire reaction surface without allowing any mixing of the gas. Also, it is necessary for the separator plate 10 to have good conductivity to connect adjacent cells among them electrically. Moreover, the electrolyte membrane exhibits strong acidity and it is therefore necessary for the separator plate to have corrosion resistance. For this reason, the separator plate 10 is currently formed by cutting a thin plate out of a graphite material and by forming a flow passage for supplying the reaction gas on the front side and back side of the separator plate 10 by carrying out a cutting process using a cutting tool such as an end mill.

However, the intervention of such mechanical processing during the course of production of a fuel cell is a large cause of an increase in the processing cost of the separator plate and hence the production cost of the fuel cell itself. Specifically, the shape of the reaction gas flow passage is diversified, fined and complicated depending on the type of fuel cells and therefore, precise mechanical processing is conducted on each separator plate as a subject while controlling an end mill corresponding to each flow passage pattern. This mechanical processing is a main cause of an increase in the production cost of the separator plate. It is said that about 40% of the production cost of a fuel cell used as the power source for automobiles is the cost of the separator plate.

It is therefore proposed to apply techniques such as screen printing to the formation of a reaction gas flow passage (Japanese Patent Application Laid-Open No. 2000-294257: Patent Document 1). Patent Document 1 reveals that a rib for constituting a gas passage is formed by applying a conductive paste to a separator plate by the screen printing method, thereby making it possible to simplify the process of producing a fuel cell and reduce the production cost.

Patent Document 1: Japanese Patent Application Laid-Open No. 2000-294257

According to the screen printing, an ink composition used as a partition wall formation material for forming a flow passage is extruded from a printing mesh cloth to form a conductive ink layer having a relatively large thickness as the partition film defining a groove which is to be a flow passage of reaction gas, on a material (on a separator plate) to be printed, thereby enabling a flow passage having various and desired patterns to be easily formed. Also, because the screen printing is suitable to any of a small lot and a large lot production form, this is an effective method to form the gas passage with a three-dimensional pattern on the separator for fuel cell in the technical field of the present invention.

### DISCLOSURE OF THE INVENTION

### Problem to be Solved by the Invention

However, the flow passage of reaction gas on the separator plate for fuel cell is usually required to secure the necessary amount of flow gas which is defined by the specification of each cell exactly and uniformly. For this reason, it is necessary that a three-dimensional pattern form such as the width of the groove as the flow passage of the reaction gas and the height of the partition wall can be formed with high accuracy and these formed pattern forms can be maintained without change even after the fuel cell is fabricated. In light of this, since the groove which is the flow passage of the reaction gas is formed by the partition wall of the ink composition in this screen printing method, there is a fear that the shapes of the groove and partition wall are collapsed more easily than in the case of cutting processing due to fluidity of the ink composition, which is in the fluid state at the time of and immediately after printing. When the sectional shape of the groove is changed or the edge of the partition wall is chipped, causing the formation of a leak part in the course of the flow passage, the desired amount of flow gas is not obtained and therefore, a reduction or variation in the performance of the battery cannot be avoided.

The inventors of the present invention have made a pretest for an attempt to apply a conductive ink composition to the surface of a carbon plate by one screen printing operation using a printing mesh cloth having 18 openings 0.8 mm in width, 22 mm in length and 0.3 mm in thickness to form a pattern of a reaction gas flow passage. However, the partition wall formed as the conductive ink layer was deformed and specifically, deformations such as collapsing and sagging were observed at the top thereof and also, indentations were formed at the end thereof, so that no pattern having a desired groove shape could be obtained. It was therefore found that it is very difficult to form a three-dimensional pattern form such as the width of the groove as the flow passage of the reaction gas and the height of the partition wall by one application of an ink composition even in the case of the screen printing method.

As mentioned above, in order to obtain a practical separator plate by applying the screen plating method to the formation of the reaction gas flow passage of the separator plate of a fuel cell, it is necessary to always secure a highly accurate pattern required for the reaction gas flow passage when the pattern is formed.

It is a primary object of the present invention to provide a method of producing a separator plate for fuel cell, the method enabling the production of a practical, highly accurate, intact and fine gas flow passage on the separator plate used in a fuel cell by using the screen printing method.

Also, it is another object of the present invention to provide a separator plate obtained by the above production method and also to provide a fuel cell using this separator plate.

### Means for Solving the Problem

The above problem can be solved by a method of producing a separator plate for fuel cell according to claim 1 of the present invention, the method including forming a partition wall having a predetermined pattern which is to be a reaction gas flow passage on a base plate, wherein two or more coats of an ink composition containing a conductive material are laminated on the base plate by screen printing in an overlapped manner to form a conductive ink layer having a predetermined thickness as a partition wall.

The above problem can be solved by an invention of claim 2 according to claim 1 directed to the method of producing a separator plate for fuel cell, wherein the ink composition is an inky material obtained by dispersing a mixture of a binder resin and a conductive material in a solvent.

The above problem can be solved by an invention of claim 3 according to claim 1 directed to the method of producing a separator plate for fuel cell, the method further including carrying out heat treatment for drying after the conductive ink layer is formed by printing and before a subsequent next conductive ink layer is formed by printing.

The above problem can be solved by an invention of claim 4 according to claim 1 directed to the method of producing a separator plate for fuel cell, wherein when the conductive ink layers for forming the partition wall are formed by recoating, a width of each printing pattern is gradually reduced toward a top layer side.

The above problem can be solved by an invention of claim 5 according to claim 1 directed to the method of producing a separator plate for fuel cell, the method further including carrying out heat treatment for thermally decomposing a binder resin contained in the conductive material after all conductive ink layers which are to be the partition wall are formed.

The above problem can be solved by an invention of claim 6 according to claim 1 directed to the method of producing a separator plate for fuel cell, wherein a place where no pattern is printed is provided at a part other than the place where the flow passage is formed by the conductive ink layer, to thereby save an amount of the ink composition to be used.

The above problem can be solved by an invention of claim 7 according to claim 1 directed to the method of producing a separator plate for fuel cell, wherein an elastic material having elasticity is applied in a predetermined thickness by screen printing to a peripheral region of the base plate on which the reaction gas flow passage is formed to thereby form a gasket.

The above problem can be solved by an invention of claim 8 according to claim 7 directed to the method of producing a separator plate for fuel cell, the method further including carrying out heat treatment for thermally decomposing a binder resin contained in the elastic material after the gasket is formed.

The above problem can be solved by an invention of claim 9 directed to a separator plate for fuel cell, the separator plate being obtained by the method of producing a separator plate for fuel cell according to any one of claims 1 to 8.

The above problem can be solved by an invention of claim 10 directed to a fuel cell using the separator plate for fuel cell according to claim 9.

### Effect of the Invention

According to the present invention, the three-dimensional pattern of a partition wall defining the reaction gas flow passage can be formed with high accuracy without any defects by the screen printing method and therefore the present invention produces the effect of remarkably reducing the production cost of a separator plate and hence the production cost of a fuel cell.

### BRIEF DESCRIPTION OF THE DRAWINGS

FIG. 1 is a flowchart of an embodiment of a method of producing a separator plate for fuel cell according to the present invention.

FIG. 2 is a sectional view of a separator plate formed with a pattern of a reaction gas flow passage.

FIG. 3 is a sectional view of a separator plate formed with a partition wall decreased in width with decrease in distance from the upper side.

FIG. 4 is a plan view of a separator plate.

FIG. 5 is a graph showing the relation between the number of printings and the total thickness of conductive ink layers on a separator plate obtained by the method of the present invention.

FIG. 6 is a graph showing the relation between the film thickness of a conductive ink layer formed by the method according to the present invention and electric resistance of the conductive ink layer.

FIG. 7 is a graph showing the result of comparison of performance between a separator plate and a commercially available separator plate when these separators are dried at 140° C. for 10 minutes.

FIG. 8 is a graph showing the result of comparison of performance between the both separator plates after the aging shown in FIG. 7.

FIG. 9 is a graph showing the result of comparison of performance between a separator plate and a commercially available separator plate when these separators are treated under heating and pressure by pressing at 140° C.

FIG. 10 is a graph showing the result of comparison of performance between a separator plate and a commercially available separator plate when these separators are treated under heating and pressure by pressing at 250° C.

FIG. 11 is an explanatory view showing the structure of a unit cell of PEMFC.

### DESCRIPTION OF REFERENCE NUMERALS

1 Cell

3 Electrolyte membrane

5 Hydrogen electrode

5a Support current collector

7 Oxygen electrode

7a Support current collector

10 Separator plate

10a Base plate

11 Partition wall

11a to 11e Conductive ink layers

13 Flow passage formation part

15 Groove

20 Gasket

20a to 20e Gasket layers

21 Unprinted part

23 Manifold hole

25 Bolt hole

### BEST MODE FOR CARRYING OUT THE INVENTION

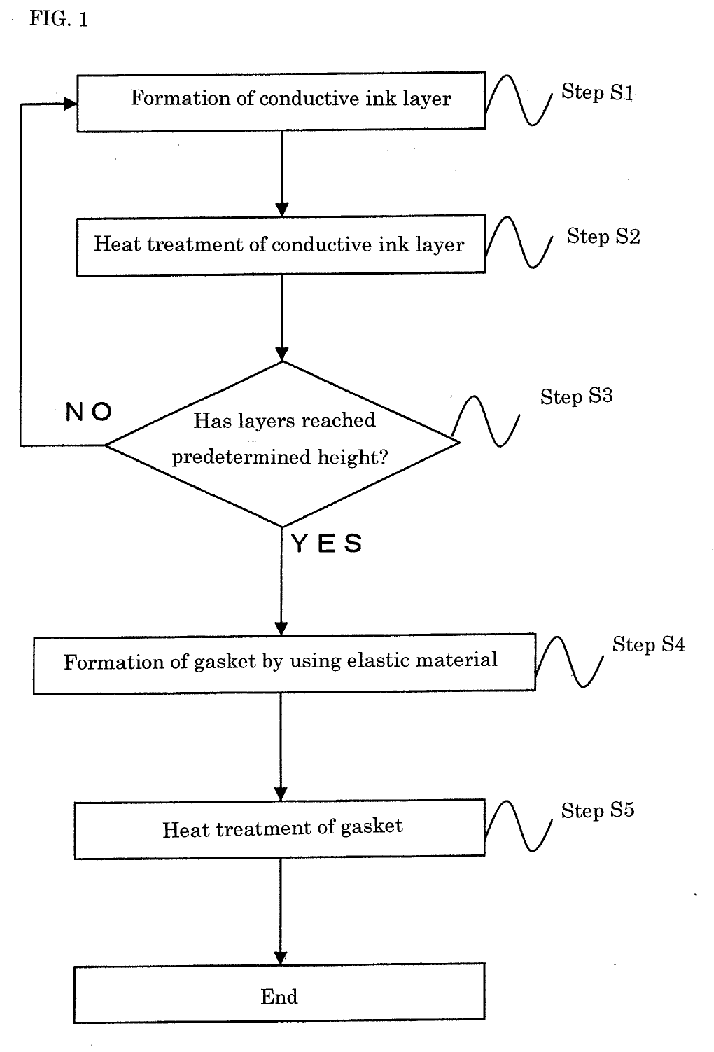

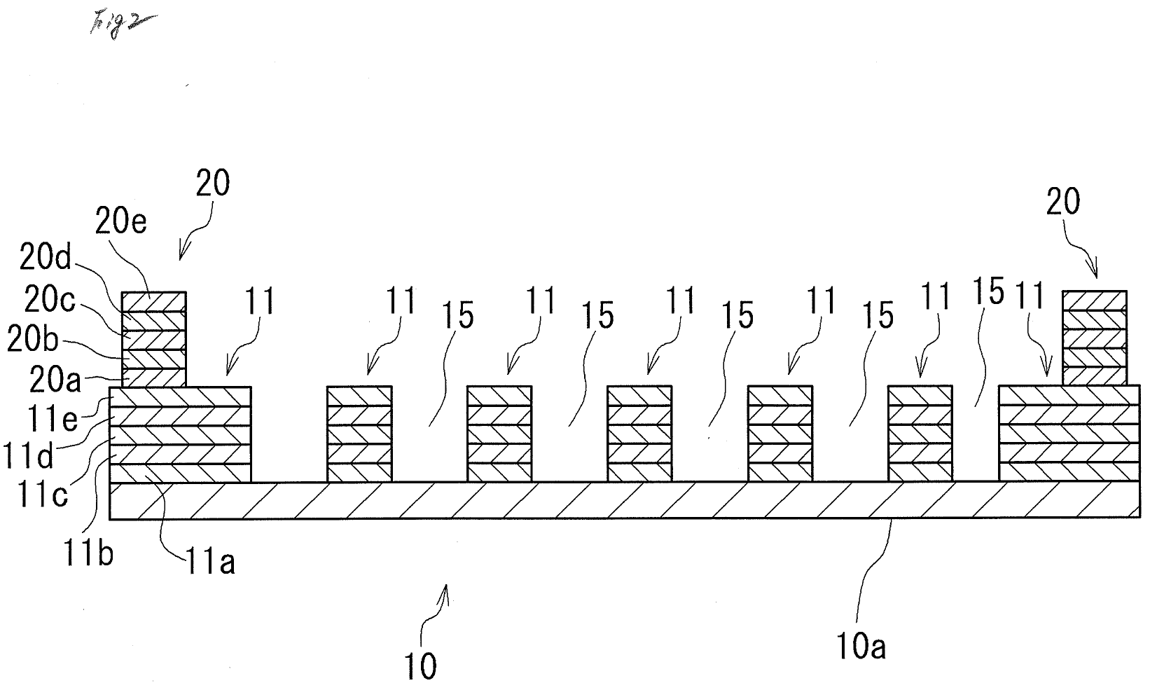

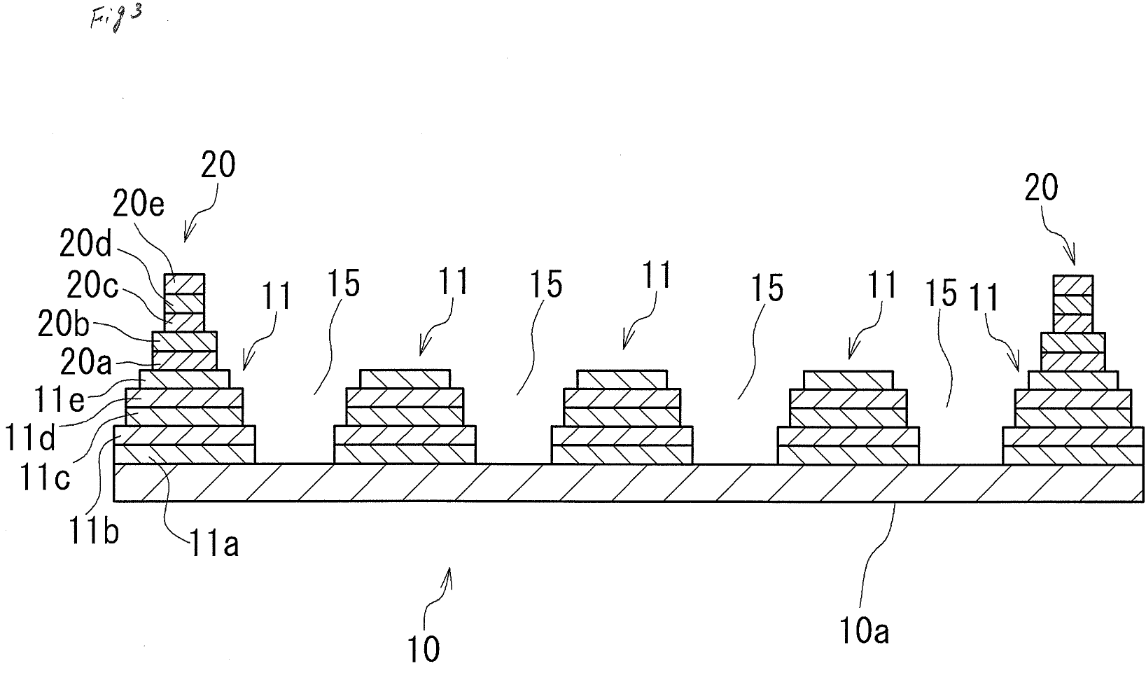

A method of producing a separator plate for fuel cell according to the present invention and a fuel cell utilizing the separator plate will be explained in detail with reference to the drawings. FIG. 1 is a flowchart of an embodiment of a method of producing a separator plate for fuel cell according to the present invention and FIG. 2 is a sectional view of a separator plate formed with a pattern of a reaction gas flow passage.

First, an ink composition to be used as the printing ink in the method of producing a separator plate for fuel cell according to the present invention is constituted by blending a resin component as a binder, a conductive material such as graphite or carbon black as a conductive filler, a solvent and, according to the need, a known appropriate adjuvant.

These components may be mixed by kneading them using a roll mill or the like. As to the amount of the conductive material to be mixed, the amount is preferably larger in consideration of printing and volumetric shrinkage when the separator plate is dried. However, if the proportion of the conductive material is increased, the fluidity of the ink composition is reduced, making printing difficult. In this case, the fluidity can be improved by increasing the amount of the solvent. However, if the amount of the solvent to be used is too large, this is undesirable because the volume of the plate is decreased when the plate is dried.

As the printing mesh cloth used in the screen printing, a proper one is selected in consideration of, for example, the amount of the ink composition passing therethrough and the state of the shape of the conductive ink layer. The screen mesh is preferably about 100. When the value of the mesh is large, the amount of the ink to be transferred is reduced whereas when the value of the mesh is small, the shape characteristics are deteriorated. In the case of, for example, a 50-mesh printing mesh cloth, there is a large possibility of generation of the groove pattern having indentations.

An opening pattern corresponding to a desired pattern of the reaction gas flow passage is formed on the printing mesh cloth and then the ink composition is extruded by a squeegee to apply the ink composition to a base plate 10a which is a material to be printed, to thereby form a partition wall 11 defining a groove 15 which is to be the reaction gas flow passage by conductive ink layers 11a to 11e which are respectively a printed coating film of the ink composition (step S1).

As the base plate 10a, an arbitrary material used as the separator in conventional fuel cells, for example, a carbon plate may be used. In conventional technologies, a groove having a desired pattern is formed on such a carbon base plate by an end mill or the like. This, however, is a main cause of increase in the production cost of the separator and hence in the production cost of a fuel cell. In the case of fuel cells used in applications for which long term durability is not required, a metal material such as stainless steel may be used as the base plate.

In the present invention, on the other hand, a pattern corresponding to the reaction gas flow passage having a predetermined form is printed on a printing mesh cloth, and using this screen, a process in which one pass printing is made on the base plate 10a is carried out. It is only necessary in the present invention to repeat this process two or more times, and therefore, the processing is significantly simple and also, it is unnecessary to introduce a large-scale mechanical processing assembly, making it possible to reduce the production cost remarkably.

The partition wall 11 formed by the screen printing is easily deformed or collapsed during printing or just after printing due to the fluidity of the ink composition, and there is therefore a fear that the sectional shape of the groove 15 is changed and the end of the partition wall 11 is chipped. In the case where a leak area arises between the reaction gas flow passages, a desired amount of gas is not obtained. Therefore, in the present invention, the conductive ink layers 11a to 11e are formed by applying a conductive ink layer two or more times in an overlapped manner when the partition wall 11 having a predetermined height is formed. Specifically, a flow passage pattern is formed by relatively thin conductive ink layers 11a to 11e in each screen printing and the coating of each of the conductive ink layers 11a to 11e is repeated until the partition wall 11 having a desired height is obtained. According to this method, the conductive ink layers 11a to 11e each formed by one printing operation are low in thickness, so that the shape of the ink layer is relatively stable, which reduces a fear that defects such as “crack” and “peeling” are generated.

Also, heat treatment is carried out to dry the conductive ink layer 11a prior to the printing of the conductive ink layer 11b next to the formed first conductive ink layer 11a (Step 2). After the conductive ink layer 11a is dried under heating, the similar conductive ink layer 11b is formed on the conductive ink layer 11a by the subsequent printing step, and this process is repeated two or more times. This repeated coating more reduces the collapsing and deformation of the shape as a whole as compared with the conventional one-time coating, ensuring that the partition wall 11 reduced in defects such as crack, peeling and tearing can be formed (Step 3).

Even in the case of this recoating, there is a case where “sagging” and the like are increased at the printed part on the upper layer side depending on the pattern shape and the width of the conductive ink layers 11a to 11e so that the shape of the partition wall 11 is not stable with increase in the height of the partition wall 11 resulting from increase in the number of repeated coatings.

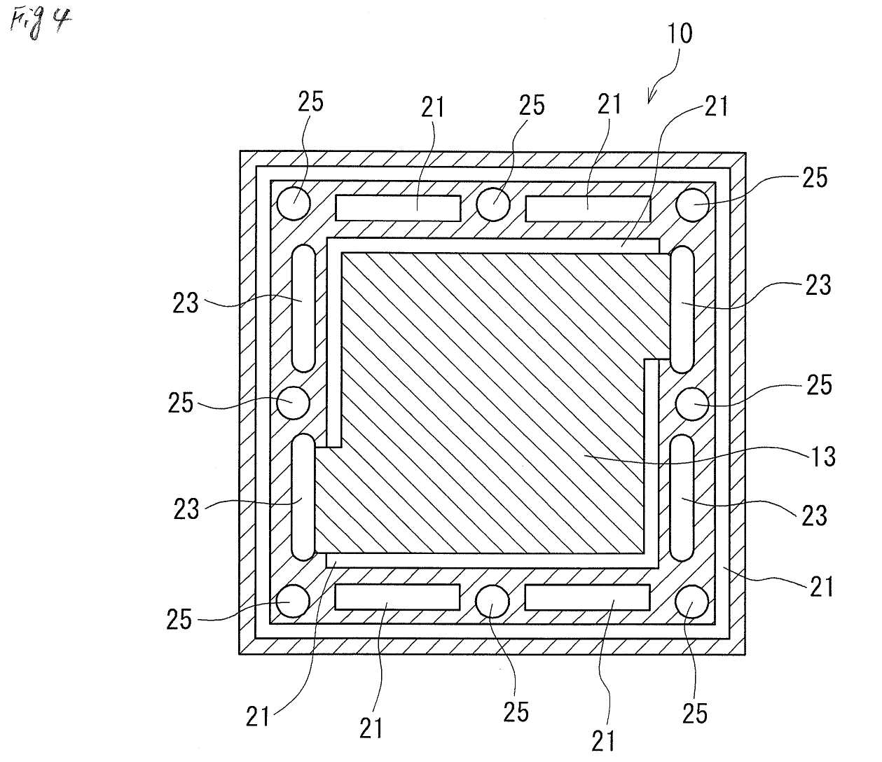

In this case, it is preferable that the printing widths of the conductive ink layers 11a to 11e be made gradually narrower toward the upper layer side in the recoating process as shown in FIG. 3. In order for the printing widths of the conductive ink layers 11a to 11e to be gradually narrower, several printing mesh cloth patterns narrowed corresponding to the above layers are prepared and used by turns, making it possible to obtain an intended partition wall.

Here, in the fuel cell of the present invention, the binder resin which is a constituent material of the ink composition is decomposed by the heat generated by current and chemical reaction in the operation, and there is a fear as to poisoning of the catalyst contained in the electrode, resulting in deteriorated performance. For this reason, it is preferable to carry out heat treatment after the reaction gas flow passage is formed on the separator plate 10 by the conductive ink layers 11a to 11e to prevent generation of the poisoning. The heat treating temperature in this case differs depending on the structure of the ink composition to be used. However, the decomposition temperatures of most binder resins are in the range of 250° C. to 300° C. and the removing effect to be intended is obtained by carrying out heat treatment at a predetermined temperature in the above range according to the type of binder resin used.

This heat treatment may be carried out each time the printing of each of these conductive ink layers 11a to 11e is finished. The ink composition is thereby cured under heating each time each layer is formed by printing and therefore, the effect of stabilizing the shape of the partition wall owing to the recoating is more increased.

On the other hand, the amount of the ink composition to be used can be saved by providing a place free from printing at a part other than the part where the groove 15 which is to be the reaction gas flow passage is formed by the conductive ink layers 11a to 11e. Specifically, as shown in FIG. 4, the provision of an unprinted place 21 free from printing at the peripheral part other than the flow passage formation part 13 which is the part where the groove 15 to be the reaction gas flow passage on the base plate 10a is formed allows a saving in the amount of the ink composition. Also, a positioning effect may be expected which is due to the engagement between the part where no printing is made and the pattern of the printing mesh cloth. Reference numeral 23 in FIG. 4 represents a manifold hole and 25 represents a bolt hole.

After the formation of the groove 15 which is to be the gas flow passage is finished, an elastic material having elasticity is applied in a predetermined thickness to the peripheral part of the separator plate by the screen printing in the same manner as in the formation of the conductive ink layers 11a to 11c to thereby form a gasket 20 with a predetermined pattern (Step S4). Because it is necessary to form the groove 15 with high accuracy in the case of the conductive ink layers 11a to 11e forming the flow passage pattern, it is designed to make two or more printings. However, in the case of the gasket, the number of printings is not particularly limited because, unlike the case of the flow passage, it is only necessary to firmly seal the gasket even if there are slight indentations at the edge. It is needless to say that like the case of the conductive ink layers 11a to 11e, exact gasket layers 20a to 20e can be formed by separate two or more printings. Then, after the pattern of the gasket 20 is formed, the same heat treatment as above is performed so as to prevent the catalyst in the electrode from being poisoned by resin components contained in the elastic material (Step S5). In the case of the gasket 20, if it is exposed to such a high-temperature atmosphere as to thermally decompose resin components, there is a fear that the sealing ability of the gasket is impaired, and it is therefore preferable to carry out heat treatment at a temperature which barely allows the resin components to proceed with the reaction.

### EXAMPLE 1

Production of a gas flow passage by printing of a conductive material on a carbon separator

### Method of Producing an Ink Composition

10 g of graphite was added to 50 g of “DOTITE” (manufactured by Fujikura Kasei Co., Ltd.) using a polyester resin as the binder resin and these components were mixed using a mixer capable of stirring with centrifugal rotation. The mixture was granulated and mixed by a three-roll mill to prepare a printing ink composition.

Using a 100-mesh screen, printing precursor plates having a pattern of a groove to be a predetermined gas flow passage were produced to make screen printing necessary times. Specifically, the ink composition was formed on a carbon plate by printing using a squeegee in such a manner as to obtain a conductive ink layer 25 μm in thickness each time to form each layer. This printing step was repeated 20 times at specified intervals to obtain a partition wall having a total height (thickness) of 500 μm. After each printing step, the plate was heated to 140° C. to vaporize solvent to dry. In this case, there were prepared several printing mesh cloth patterns made different such that the printing width of the upper layer is more decreased each time each layer is formed by printing.

After the pattern of the flow passage was formed, the separator plate was heated to about 270° C. to prevent the catalyst from being poisoned by catalyst poisoning components generated by thermal decomposition of the binder resin in the pattern of the conductive ink layer during use of the fuel cells. This heat treatment may be carried out every time the formation of one conductive ink layer is finished. This makes it possible to more stabilize the shape of each layer in the recoating.

After the gas flow passage was formed, a gasket pattern was formed on the periphery of the separator plate by the screen printing method using a silicon rubber type composition “RTV” (manufactured by Shin-Etsu Silicones) in the same manner as above and then, the same heat treatment as above was carried out. In the case of “RTV”, although a curing reaction proceeds at ambient temperature, heat treatment may be optionally carried out to accelerate the reaction.

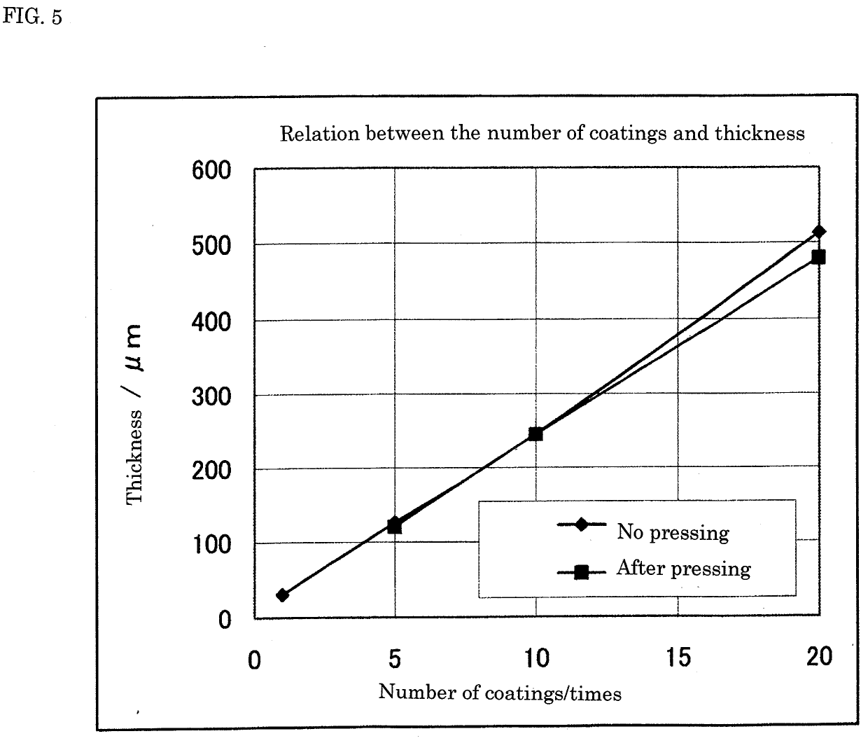

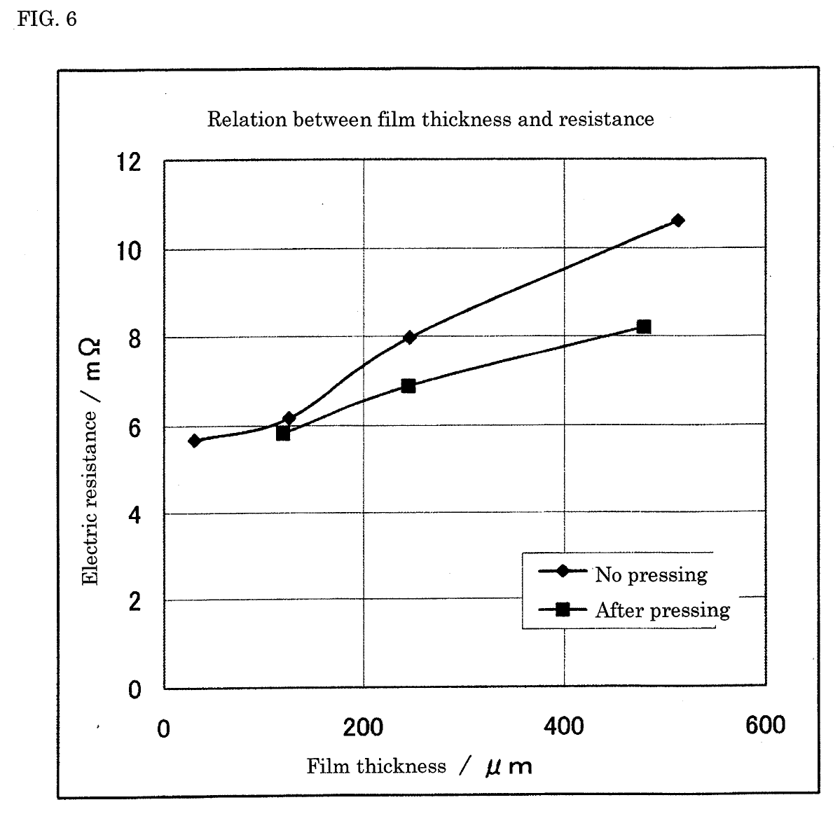

The separator plate obtained in this manner has formed thereon a groove 15 which is to be a gas flow passage having a desired shape by a partition wall 11 free from collapsing and deformation as shown in FIGS. 1 and 2. Also, it was confirmed that the thickness of the partition wall 11 of the reaction gas flow passage was linearly increased corresponding to the number of recoatings of the conductive ink layers (see FIG. 5). Also, although the increase in the thickness of the coating layer due to recoating is accompanied by an increase in electric resistance, the increase in resistance can be limited by pressure and heating treatment using press treatment (see FIG. 6).

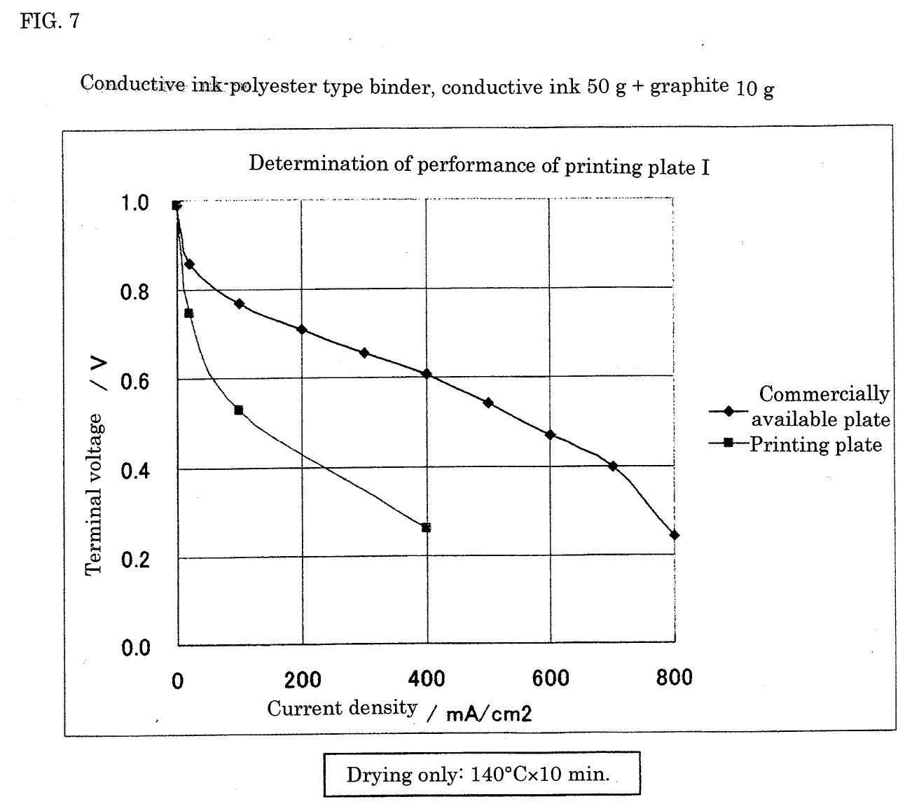

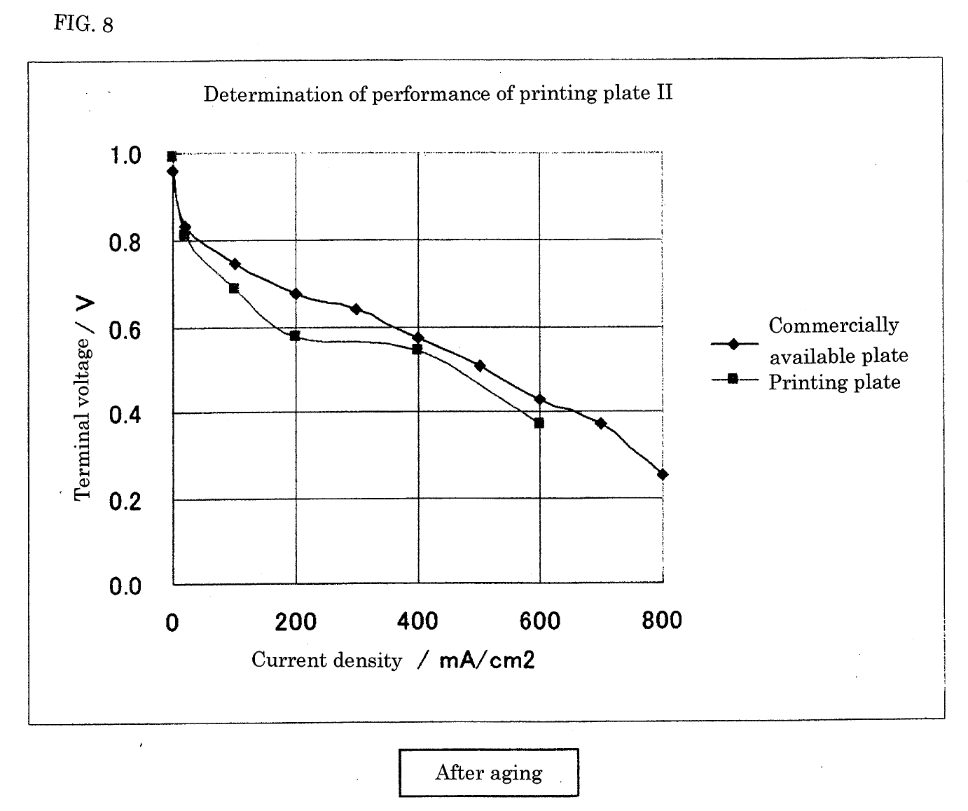

The influence of poisoning caused by the decomposition of resin components as the binder contained in the ink composition is shown in FIG. 7. FIG. 7 is a graph showing the result of comparison of performance between a separator plate and a commercially available separator plate when these separators are dried at 140° C. for 10 minutes using polyester resin as a binder. The result clearly shows the influence of poisoning caused by the resin components. On the other hand, FIG. 8 is a graph showing the result of comparison of performance between the both separator plates after the aging is carried out at 80° C. at a current density of 600 mA/cm². Although it is shown that the influence of poisoning caused by the resin components is reduced by the aging, this separator plate has a more unstable performance than the commercially available separator plate. In light of this, the separator plate was subjected to heat treatment performed under pressure by press treatment in the conditions of 140° C., 1 MPa and 1 min. and 250° C., 1 MPa and 1 min. As a result, a difference in performance was observed between the separator plate treated at 140° C. and the commercially available separator plate. On the other hand, it was found that the separator plate treated at 250° C. could exhibit the same performance as the commercially available separator plate.

Using the separator plate obtained in this manner in place of the separator plate of a commercially available fuel cell, a unit fuel cell was fabricated to measure cell output, with the result that the output characteristics almost equal to those of the commercially available product were obtained as shown in Table 1, showing that the obtained fuel cell sufficiently copes with practical use.

TABLE 1

Current density mA/cm²

| | 0 | | | |
|---|---|---|---|---|
| | (Open circuit) | 20 | 400 | 600 |
| Example | 0.993 | 0.812 | 0.544 | 0.374 |
| Comparative | 0.958 | 0.831 | 0.575 | 0.431 |
| Example | | | | |

FIG. 1

Step S1: Formation of conductive ink layer

Step S2: Heat treatment of conductive ink layer

Step S3: Has layers reached predetermined height?

Step S4: Formation of gasket by using elastic material

Step S5: Heat treatment of gasket

End

FIG. 5

Relation between the number of coatings and thickness

Thickness

Number of coatings/times

No pressing

After pressing

FIG. 6

Relation between film thickness and resistance

Electric resistance

Film thickness

No pressing

After pressing

FIG. 7

Conductive ink-polyester type binder, conductive ink 50 g+graphite 10 g

Determination of performance of printing plate I

Terminal voltage

Current density

Commercially available plate

Printing plate

Drying only: 140° C.×10 min.

FIG. 8

Determination of performance of printing plate II

Terminal voltage

Current density

Commercially available plate

Printing plate

After aging

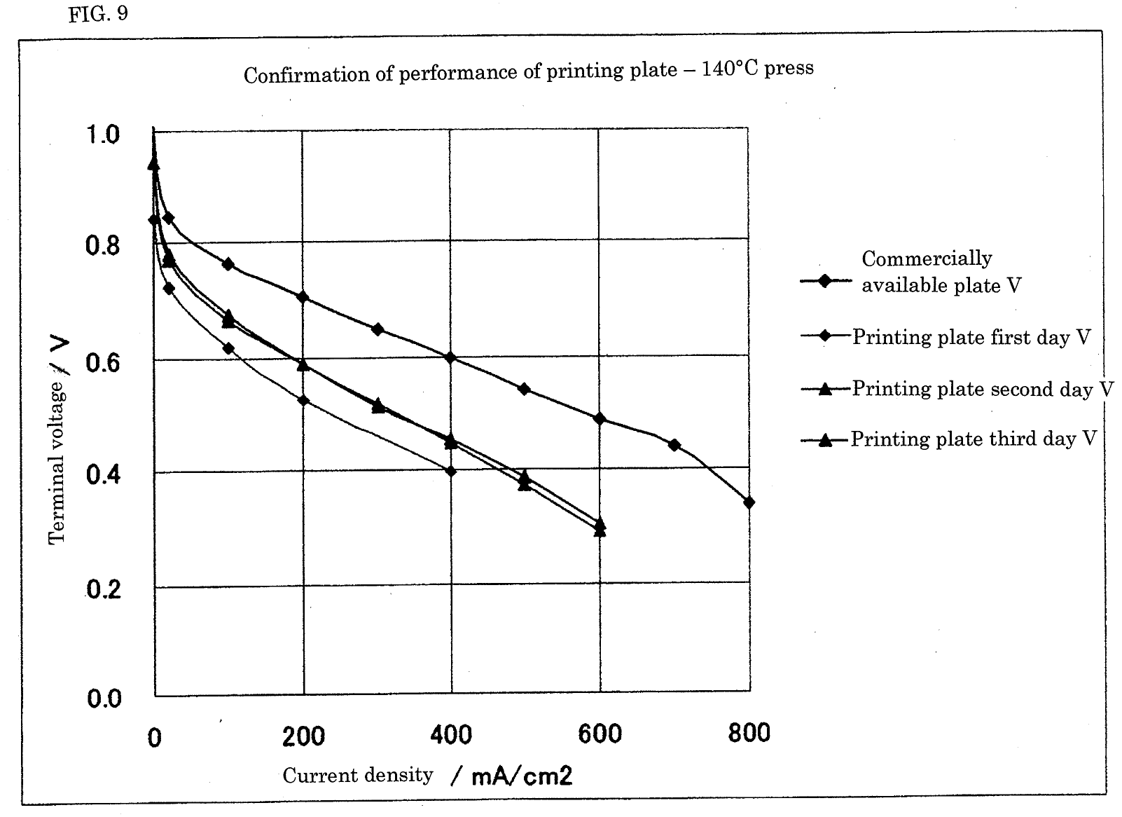

FIG. 9

Confirmation of performance of printing plate—140° C. press

Terminal voltage

Current density

Commercially available plate V

Printing plate first day V

Printing plate second day V

Printing plate third day V

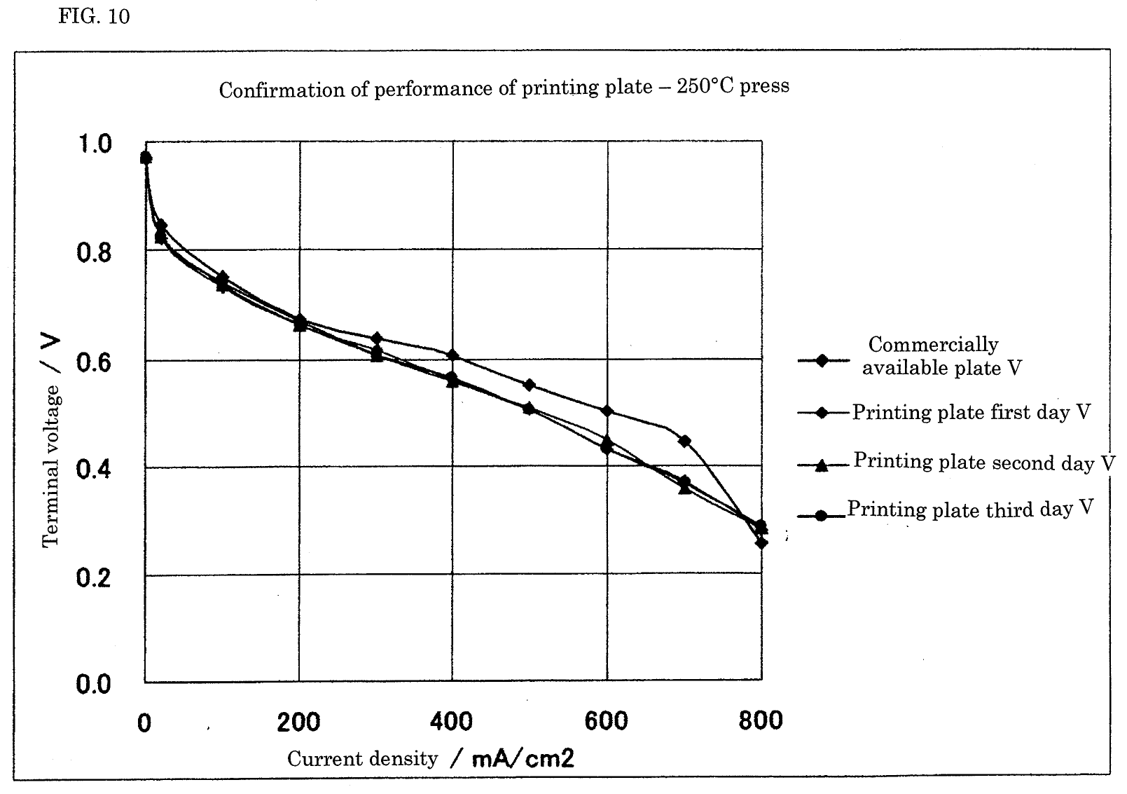

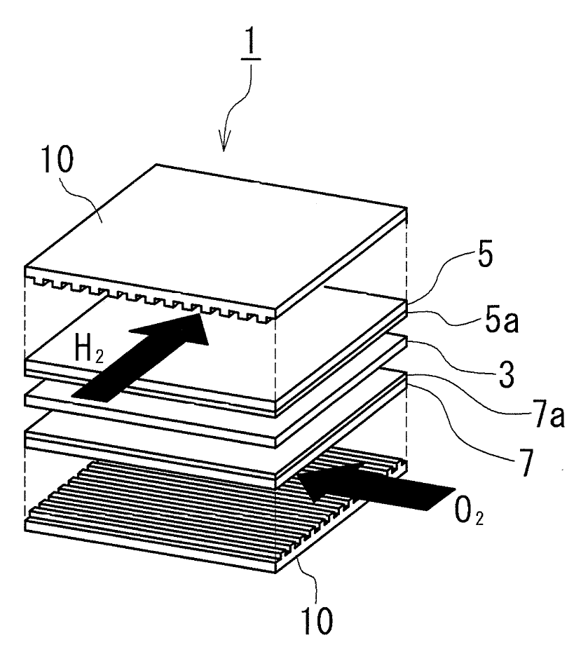

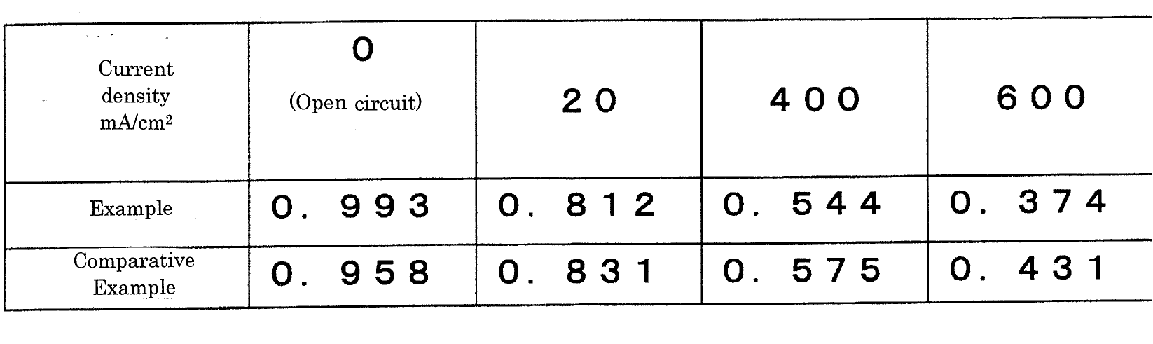

FIG. 10

Confirmation of performance of printing plate—250° C. press

Terminal voltage

Current density

Commercially available plate V

Printing plate first day V

Printing plate second day V

Printing plate third day V

1. A method of producing a separator plate for fuel cell, comprising forming a partition wall having a predetermined pattern which is to be a reaction gas flow passage on a base plate by printing,
wherein two or more coats of an ink composition containing a conductive material are laminated on the base plate by screen printing to form a conductive ink layer having a predetermined thickness as a partition wall.

2. The method of producing a separator plate for fuel cell according to claim 1, wherein the ink composition is an inky material obtained by dispersing a mixture of a binder resin and a conductive material in a solvent.

3. The method of producing a separator plate for fuel cell according to claim 1, further comprising:
carrying out heat treatment for drying after the conductive ink layer is formed by printing and before a subsequent next conductive ink layer is formed by printing.

4. The method of producing a separator plate for fuel cell according to claim 1, wherein when the conductive ink layer for forming the partition wall is formed by recoating, a width of each printing pattern is gradually reduced toward a top layer side.

5. The method of producing a separator plate for fuel cell according to claim 1, further comprising:
carrying out heat treatment for thermally decomposing a binder resin contained in the conductive material after all conductive ink layers which are to be the partition wall are formed.

6. The method of producing a separator plate for fuel cell according to claim 1, wherein a place where no pattern is printed is provided at a part other than the place where the flow passage is formed by the conductive ink layer, to thereby save an amount of the ink composition to be used.

7. The method of producing a separator plate for fuel cell according to claim 1, wherein an elastic material having elasticity is applied in a predetermined thickness by screen printing to a peripheral region of the base plate on which the reaction gas flow passage is formed to thereby form a gasket.

8. The method of producing a separator plate for fuel cell according to claim 7, further comprising:
carrying out heat treatment for thermally decomposing a binder resin contained in the elastic material after the gasket is formed.

9. A separator plate for fuel cell, the separator plate being obtained by the method of producing a separator plate for fuel cell according to any one of claims 1 to 8.

10. A fuel cell using the separator plate for fuel cell according to claim 9.
